(19) United States
(12) Patent Application Publication
(10) Pub. No.: US 2016/0004182 A1
(43) Pub. Date: Jan. 7, 2016

(54) IMAGE FORMING APPARATUS

(71) Applicant: CANON KABUSHIKI KAISHA, Tokyo (JP)

(72) Inventors: Toshihisa Yago, Toride-shi (JP); Fumiyoshi Saito, Toride-shi (JP)

(21) Appl. No.: 14/789,424

(22) Filed: Jul. 1, 2015

(30) Foreign Application Priority Data
Jul. 3, 2014 (JP) 2014-137416
Jul. 3, 2014 (JP) 2014-137417

(51) Int. Cl. G03G 15/08

(52) U.S. Cl. CPC G03G 15/0822

(57) ABSTRACT

An image forming apparatus includes: a main assembly, a developing device, a driving device, a controller, and an outputting portion for outputting information providing an instruction to remove the developing device or information about abnormally of the image forming apparatus. A developing container of the developing device includes an accommodating portion and a discharging portion. A feeding member of the developing device is constituted by integrally connecting a main feeding portion, a sub-feeding portion, and a discharging feeding portion. The controller drives the driving device for a predetermined time when the information is outputted from the outputting portion.

### FIELD OF THE INVENTION AND RELATED ART

The present invention relates to an image forming apparatus such as a copying machine, a printer, a facsimile machine, or a multi-function machine having a plurality of functions of these machines, and particularly relates to a constitution in which a developing device is removable from an apparatus main assembly of the image forming apparatus.

In a conventional image forming apparatus of an electrophotographic type, a two-component developing system in which a non-magnetic toner and a magnetic carrier are mixed and used as a developer has been widely used. In the two-component developing system a deterioration of the developer due to a long-term use, particularly a deterioration of the carrier generates, and therefore with the long-term use of the image forming apparatus, such an operation of exchange of the developer has been performed. For example, a constitution in which the developer containing a toner in an amount corresponding to an amount of the toner consumed by a developing operation of the developing device is supplied to a developing container, and an excessive developer in the developing container is discharged into a residual developer accommodating container provided outside the developing container has been proposed (Japanese Laid-Open Patent Application 2010-256701).

In the case of the above-described conventional constitution, a mechanism for discharging the excessive developer is provided with a simple shutter at a developer discharging opening of the developing container and the developer is discharged downward with respect to the direction of gravity in many cases in order to discharge the excessive developer into the residual developer accommodating container by gravitation. Accordingly, when the developing device is removed (demounted) from the apparatus main assembly for maintenance, exchange of the developing device or the like, there is a possibility that the developer accumulated in the neighborhood of the developer discharging opening drops. For example, due to vibration of the developing device in a removing operation, tilt of the developing device during the removal or the like, the developer drops from the neighborhood of the shutter at the developer discharging opening into the apparatus main assembly or a periphery of the apparatus main assembly in some cases. Incidentally, even in the case where the developer discharging opening is open with respect to a direction other than the (downward) direction of gravity, e.g., with respect to the horizontal direction, when the developer accumulates in the neighborhood of the developer discharging opening, there is a possibility that the developer drops during the removal of the developing device.

### SUMMARY OF THE INVENTION

The present invention has been accomplished in view of the above circumstances. A principal object of the present invention is to suppress drop of a developer when a developing device is removed from an apparatus main assembly of an image forming apparatus.

According to an aspect of the present invention, there is provided an image forming apparatus comprising: a main assembly; a developing device removable from the main assembly and including a developing container provided with a discharge opening for permitting discharge of a developer and a feeding member for feeding the developer in the developing container; a driving device for driving the feeding member; a controller for controlling the driving device; and an outputting portion for outputting information providing an instruction to remove the developing device or information about abnormally of the image forming apparatus, wherein the developing container includes an accommodating portion for accommodating the developer and a discharging portion for feeding the developer to the discharge opening by being connected to the accommodating portion, wherein the feeding member is constituted by integrally connecting a main feeding portion, provided in the accommodating portion, for feeding the developer in the accommodating portion toward the discharging portion, a sub-feeding portion for feeding the developer in an opposite direction to a developer feeding direction of the main feeding portion in front of the discharging portion in the accommodating portion, and a discharging feeding portion, provided in the discharging portion, for feeding toward the discharging opening the developer fed from the accommodating portion to the discharging portion over the sub-feeding portion, and wherein the controller drives the driving device for a predetermined time when the information is outputted from the outputting portion.

According to another aspect of the present invention, there is provided an image forming apparatus comprising: a main assembly; a developing device removable from the main assembly and including a developing container provided with a discharge opening for permitting discharge of a developer and a feeding member for feeding the developer in the developing container; a driving device for driving the feeding member; a controller for controlling the driving device; and an inputting portion for inputting information for providing an instruction to remove the developing device, wherein the developing container includes an accommodating portion for accommodating the developer and a discharging portion for feeding the developer to the discharge opening by being connected to the accommodating portion, wherein the feeding member is constituted by integrally connecting a main feeding portion, provided in the accommodating portion, for feeding the developer in the accommodating portion toward the discharging portion, a sub-feeding portion for feeding the developer in an opposite direction to a developer feeding direction of the main feeding portion in front of the discharging portion in the accommodating portion, and a discharging feeding portion, provided in the discharging portion, for feeding toward the discharging opening the developer fed from the accommodating portion to the discharging portion over the sub-feeding portion, and wherein the controller drives the driving device for a predetermined time when the information is inputted from the inputting portion.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic structural view of an image forming apparatus according to First Embodiment of the present invention.

FIG. 2 is a perspective view of a developing device in First Embodiment.

FIG. 3 is a cross-sectional view of the developing device.

FIG. 4 is a longitudinal sectional view of the developing device.

FIG. 5 is a perspective view of a stirring and feeding screw in First Embodiment.

FIG. 6 is an enlarged plan view showing the stirring and feeding screw in a discharging screw portion side.

FIG. 7 is a block diagram showing a control circuit of the image forming apparatus in First Embodiment.

In FIG. 8, (a) is a schematic view showing an example of an operating portion of the image forming apparatus in First Embodiment, (b) is a schematic view showing an example in which exchange of the developing device is displayed at the operating portion, and (c) is a schematic view showing an example in which an error is displayed at the operating portion.

In FIG. 9, (a) to (c) are schematic views sequentially showing screens displayed at the operating portion in the case where the developing device is exchanged in First Embodiment.

FIG. 10 is a flowchart showing an example of an operation in a developing device exchange mode in First Embodiment.

FIG. 11 is a graph showing a relationship between a rotational speed of the stirring and feeding screw and a maximum developer surface height with respect to each of developer amounts.

In FIG. 12, (a) is a schematic view showing a state in which the developer is discharged in the operation in the developing device exchange mode in First Embodiment, and (b) is a schematic view showing a state after the developer is discharged.

FIG. 13 is a schematic view for explaining various parameters of a developing device in Second Embodiment of the present invention.

FIG. 14 is a schematic view showing a state in which a developer (toner) is scattered by a stirring and feeding screw.

### DESCRIPTION OF THE EMBODIMENTS

### First Embodiment

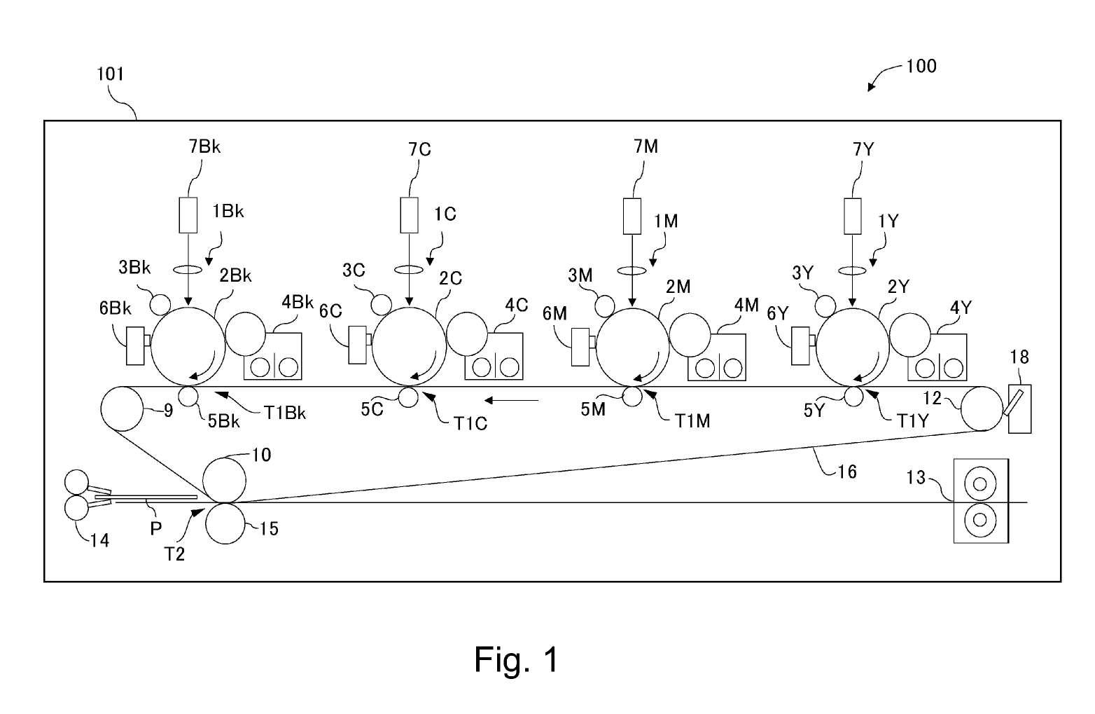

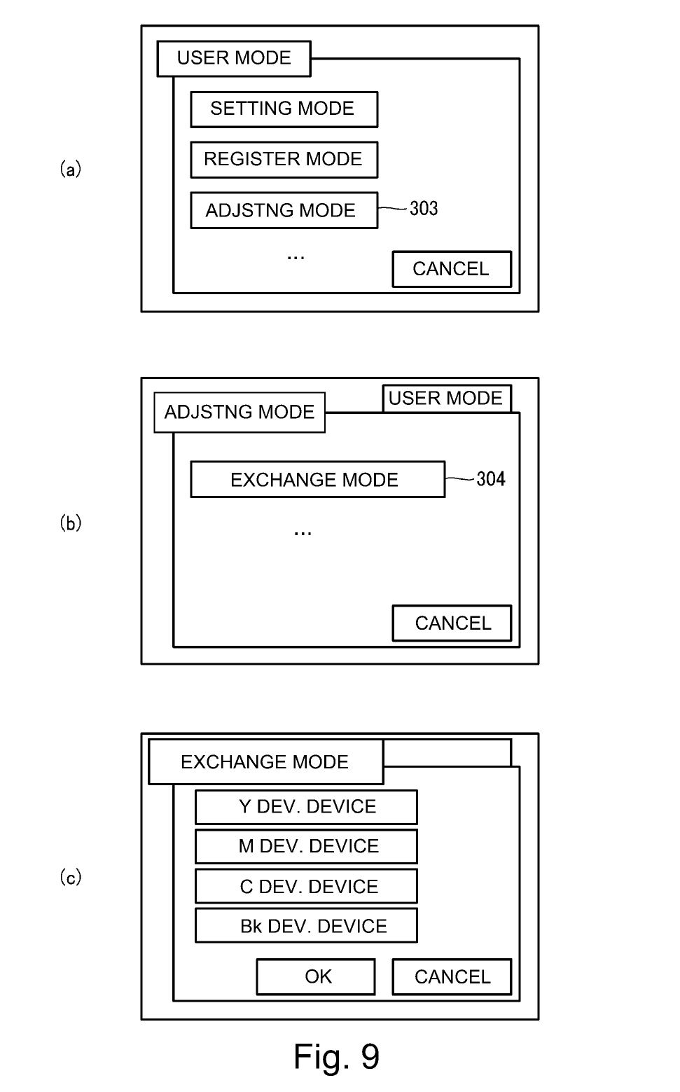

First Embodiment of the present invention will be described with reference to FIGS. 1 to 12. First, a schematic structure of an image forming apparatus in this embodiment will be described with reference to FIG. 1.

### [Image Forming Apparatus]

An image forming apparatus 100 is an electrophotographic full-color printer including four image forming portions (stations) 1Y, 1M, 1C and 1Bk provided correspondingly to four colors of yellow, magenta, cyan and black. The image forming apparatus 100 forms a toner image (image) on a recording material P depending on an image information signal from an original reading device (not shown) connected to an image forming apparatus main assembly or from a host device such as a personal computer communicatably connected to the image forming apparatus main assembly. As the recording material, it is possible to cite a sheet material such as paper, a plastic film, fabric, or the like.

An outline of such an image forming process will be described. First, toner images of respective colors are formed, at the first to fourth image forming portions 1Y, 1M, 1C and 1Bk, on photosensitive drums (electrophotographic photosensitive member) 2Y, 2M, 2C and 2Bk as an image bearing member. The thus-formed toner images of respective colors are transferred onto an intermediary transfer belt 16, and then are transferred from the intermediary transfer belt 16 onto the recording material P. The recording material P on which the toner images are transferred is fed to a fixing device 13, by which the toner images are fixed on the recording material P. This will be described below more specifically.

Incidentally, the four image forming portions 1Y, 1M, 1C and 1Bk have the substantially same constitution except that development colors are different from each other. Therefore, in the following, in the case where there is no need to particularly discriminate the constituent elements, they are collectively described by omitting the suffixes, Y, M, C and Bk added for representing the constituent elements belonging any of the image forming portions. At the image forming portion 1, a cylindrical photosensitive member as the image bearing member, i.e., the photosensitive drum 2 is provided. The photosensitive drum 2 is rotationally driven in an arrow direction in FIG. 1. Around the photosensitive drum 2, a charging roller 3 as a charging means, a developing device 4 as a developing means, a primary transfer roller 5 as a transferring means, and a cleaning device 6 as a cleaning means are disposed.

Above the photosensitive drum 2 in FIG. 1, a laser scanner 7 (expose device) as an exposure means is disposed. Further, the intermediary transfer belt 16 is disposed oppositely to the photosensitive drum 2 of each of the image forming portions 1. The intermediary transfer belt 16 is stretched by a driving roller 9, an inner secondary transfer roller 10 and a stretching between 12, and is circularly moved by the driving roller 9 in the direction indicated by an arrow in FIG. 1.

At a position opposing the inner secondary transfer roller 10 via the intermediary transfer belt 16, an outer secondary transfer roller 15 is disposed and constitutes a secondary transfer portion T2 where the toner images are transferred from the intermediary transfer belt 16 onto the recording material P. At a position downstream of the secondary transfer portion T2 with respect to a recording material feeding direction, the fixing device 13 is disposed.

A process for forming, e.g., a four-color based full-color image by the image forming apparatus 100 constitutes as described above will be described. First, when the image forming operation is started, the surface of the rotating photosensitive drum 2 is uniformly charged by the charging roller 3. In this case, a charging bias is applied to the charging roller 3 from a charging bias power (voltage) source. Then, the photosensitive drum 2 is exposed to laser light, corresponding to an image signal, emitted from an exposure device 7. As a result, the electrostatic latent image depending on the image signal is formed on the photosensitive drum 2. The electrostatic latent image formed on each photosensitive drum 2 is developed with the toner stored in the developing device 4, thus being visualized as a visible image. In this embodiment, a reverse developing method in which the toner is deposited at a light-portion potential portion exposed to the laser light is used.

The toner image formed on the photosensitive drum 2 is primary-transferred onto the intermediary transfer belt 16 at a primary transfer portion T1 constituted between the photosensitive drum 2 and the intermediary transfer belt 16 contacting the primary transfer roller 5. In this case, a primary transfer bias is applied to the primary transfer roller 5. The toner (transfer residual toner) remaining on the surface of the photosensitive drum 2 after the primary transfer is removed by the cleaning device 6.

Such an operation is successively performed at the image forming portions for yellow, cyan, magenta and black, so that the four color toner images are superposed on the intermediary transfer belt 16. Thereafter, the recording material P accommodated in a recording material accommodating cassette (not shown) is fed from a supplying roller 14 to the secondary transfer portion T2 in synchronism with toner image formation timing. The four color toner images on the intermediary transfer belt 16 are then collectively secondary-transferred onto the recording material P by applying a secondary transfer bias to the outer secondary transfer roller 15. The toner remaining on the intermediary transfer belt 16 without being not completely transferred onto the recording material P at the secondary transfer portion T2 is removed by an intermediary transfer belt cleaner 18.

Then, the recording material P is fed to the fixing device 13 as a fixing means. Then, by the fixing device 13, the toner on the recording medium P is subjected to heat and pressure to be melted and mixed, so that a full-color image is fixed on the recording material P. Thereafter, the recording material P is discharged to the outside of the image forming apparatus 100. As a result, a series of the image forming process (image forming operation) is ended. Incidentally, by using only a desired image forming portion, it is also possible to form an image of a desired single color or a plurality of colors.

### [Developing Device]

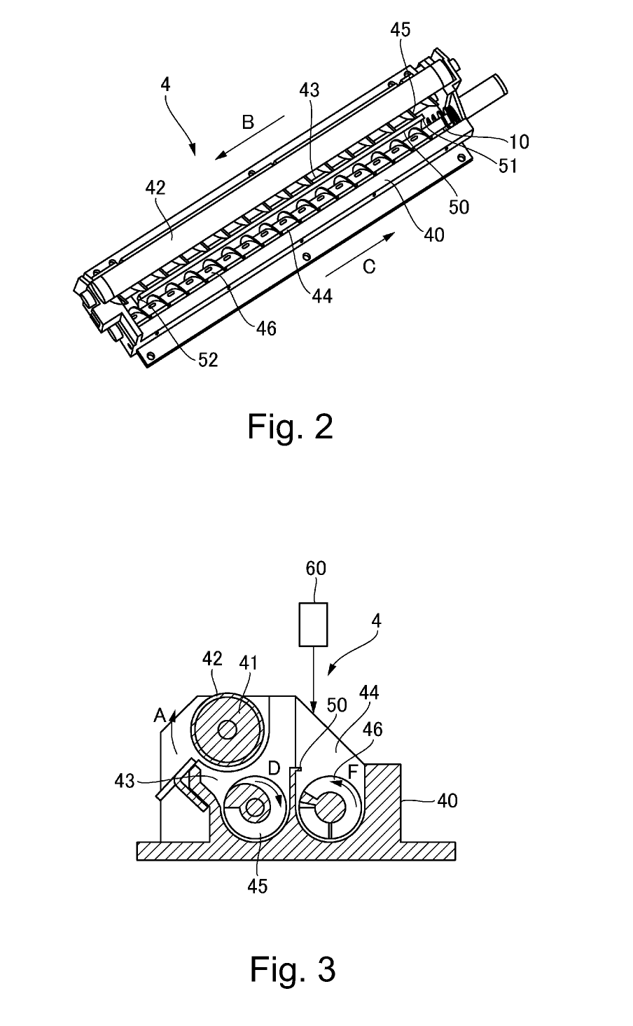

Next, using FIGS. 2 to 6, the developing device 4 in this embodiment will be described. In this embodiment, as described above all the developing devices for yellow, magenta, cyan and black have the same constitution. The developing device 4 includes a developing container 40 in which a two-component developer primarily including of nonmagnetic toner particles (toner) and magnetic carrier particles (carrier) is accommodated. Incidentally, in this embodiment, a mixing ratio between the toner and the carrier is about 1:9 in weight ratio. This ratio should be properly adjusted by a toner charge amount, a carrier particle size, a structure of the image forming apparatus 100, and the like, and therefore is not always required to be this numerical value.

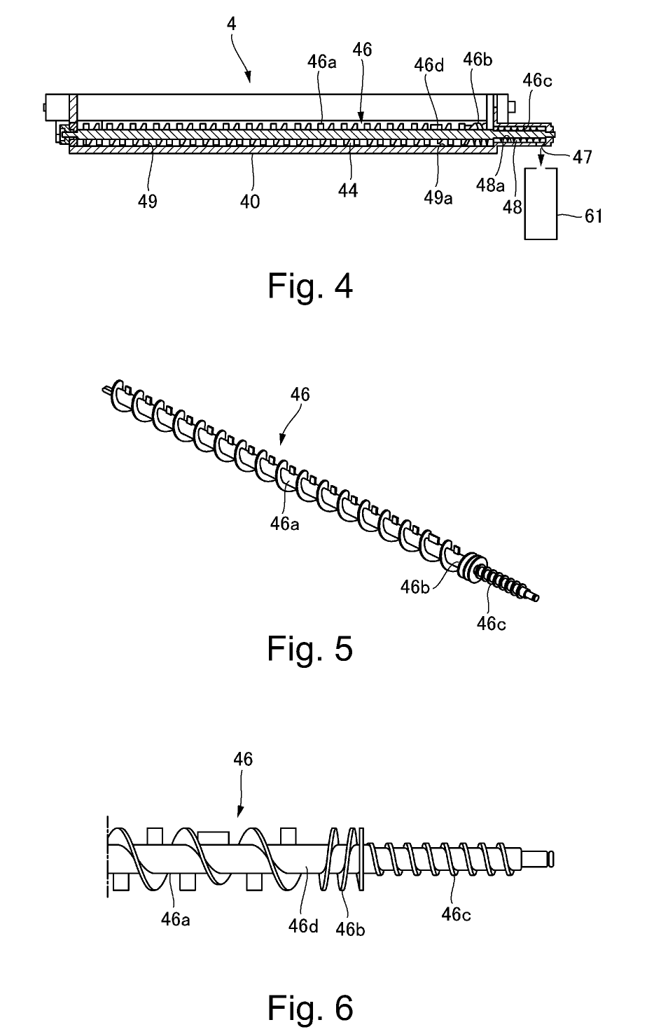

The developing device 4 is removable from an apparatus main assembly 101 (FIG. 1) of the image forming apparatus 100 and is mountable into the apparatus main assembly 101, and in a mounted state, as shown in FIG. 1, is disposed in the neighborhood of the photosensitive drum 2. The developing device 4 opens at a portion of a developing region where the developing container 40 opposes the photosensitive drum 2, and a developing sleeve 42 as a developer carrying member in which a magnet 41 is disposed in a non-rotation manner is provided rotatably so as to be partly exposed through the opening. The developing sleeve 42 is formed of a nonmagnetic material and rotates in an arrow A direction in FIG. 3 during a developing operation, and feeds the two-component developer to the developing region while carrying the two-component developer in a layer. Then, the developing sleeve 42 supplies the developer to the photosensitive drum 2 in the developing region, and develops the electrostatic latent image formed on the photosensitive drum 2. The developer after the latent image is developed is collected in the developing container 40 with rotation of the developing sleeve 42.

Inside the developing container 40, a developing chamber 43 as a first chamber capable of accommodating the developer and a stirring chamber 44 as a second chamber which forms a circulation path for circulating the developer in communication with the developing chamber 43 and which is capable of accommodating the developer are provided. Further, a first stirring and feeding screw 45 and a second stirring and feeding screw 46 as feeding members for feeding the developer in the developing chamber 43 and the stirring chamber 44, respectively, are provided. Further, the stirring chamber 44 is provided with an unshown supply opening for permitting supply of the developer containing the toner and the carrier from a developer supplying device 60 (FIG. 3).

Further, between the developing chamber 43 and the stirring chamber 44, a partition wall 50 is provided. In both end sides of this partition wall 50, as shown in FIG. 2, openings 51 and 52 for permitting delivery of the developer are provided. In this embodiment, the opening 52 is provided in a rear side of the partition wall 50, and the opening 51 is provided in a front side of the partition wall 50. FIG. 3 shows a cross-section of the developing device 4 as seen from the rear side of the apparatus main assembly 101, and the front side of FIG. 3 corresponds to the rear side of the apparatus main assembly 101. Further, by the first stirring and feeding screw 45 and the second stirring and feeding screw 46 provided in the developing chamber 43 and the stirring chamber 44, respectively, the two-component developer is fed and circulated in the developing container 40 while being stirred and mixed. A feeding direction of the developer is an arrow B direction in the developing chamber 43, and is an arrow C direction in the stirring chamber 44, so that the developer is fed in opposite directions in the developing chamber 43 and the stirring chamber 44 to each other.

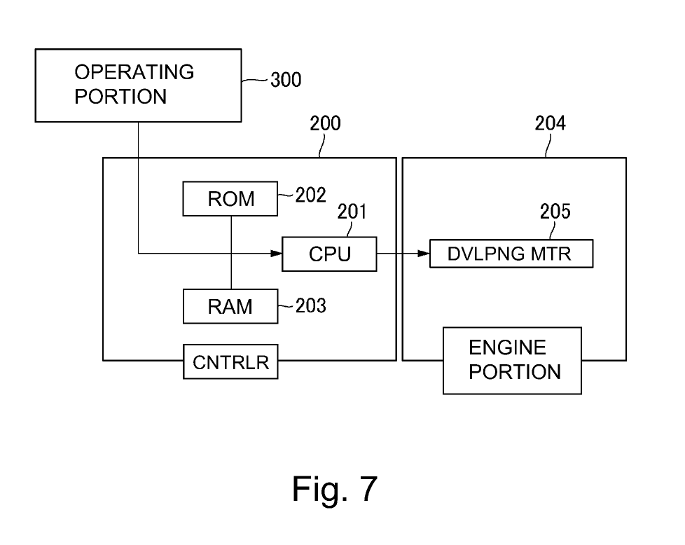

Further, the stirring chamber 44 is provided with a discharging opening 47 for permitting discharge of the developer in the stirring chamber 44 as shown in FIG. 4. The discharging opening 47 is disposed outside a circulation path in a downstream side of the developer feeding direction in the stirring chamber 44. That is, a discharging path 48 as a discharging portion is connected at a downstream end portion of the stirring chamber 44, which is also an accommodating portion for accommodating the developer, with respect to the developer feeding direction. Further, in a downstream side of the discharging path 48 with respect to the developer feeding direction, the discharging opening 47 is disposed so as to open downward with respect to the direction of gravity in an installed state.

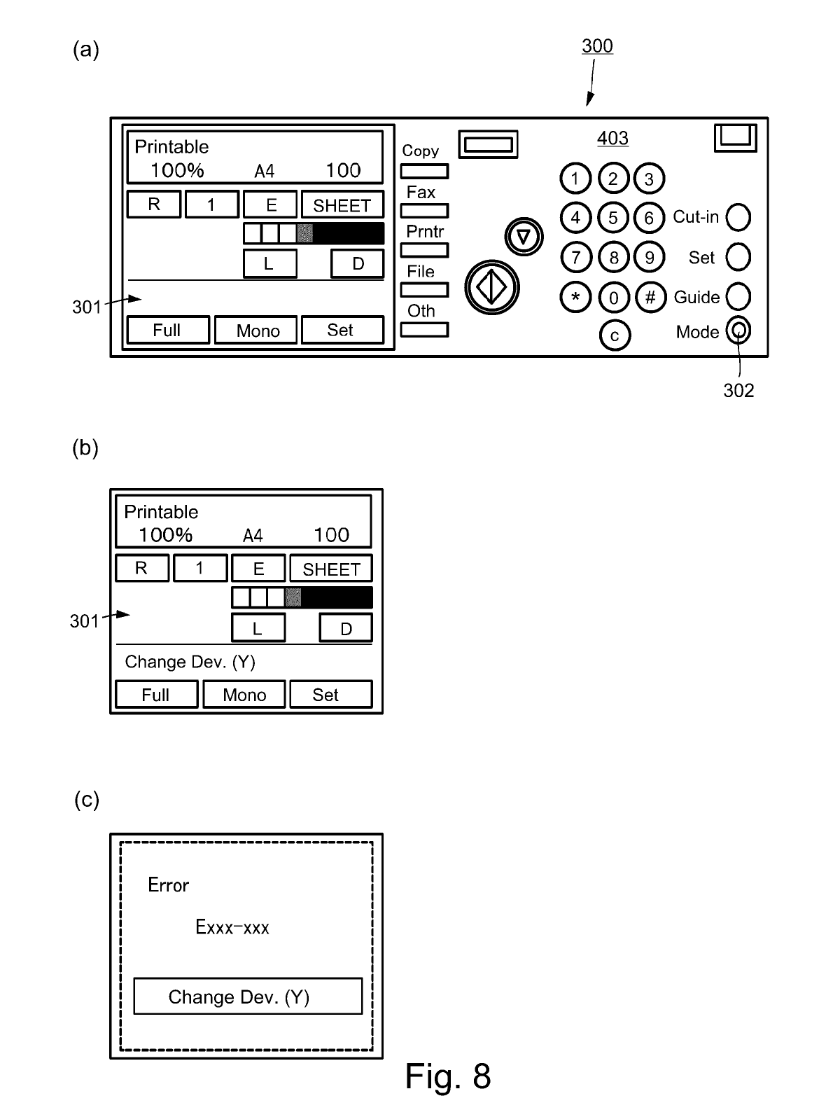

In this way, the second stirring and feeding screw 46 is constituted as shown in FIGS. 4 to 6 in order to feed the developer from the stirring chamber 44 to the discharging opening 47. That is, as shown in FIG. 5, the second stirring and feeding screw 46 is constituted by integrally connecting a main feeding screw portion 46a as a main feeding portion, a returning screw portion 46b as a sub-feeding portion, and a discharging screw portion 46c as a discharging feeding portion. Specifically, each of the screw portions is constituted by providing a helical blade on a rotation shaft 46d (rotational axis). The main feeding screw portion 46a is disposed in the stirring chamber 44 (in the accommodating portion) and feeds the developer in the stirring chamber 44 in the arrow C direction, i.e., toward the discharging path 48. The returning screw portion 46b feeds the developer in an opposite direction to the developer feeding direction by the main feeding screw portion 46a in front of the discharging path in the stirring chamber 44. Here, the expression “feeds the developer in an opposite direction” does not mean that all the developer is returned, but means that a part of the developer is fed in the opposite direction. The discharging screw portion 46c is disposed in the discharging path 48 and feeds, toward the discharging opening 47, the developer fed from the stirring chamber 44 to the discharging path 48 while climbing over the returning screw portion 46b.

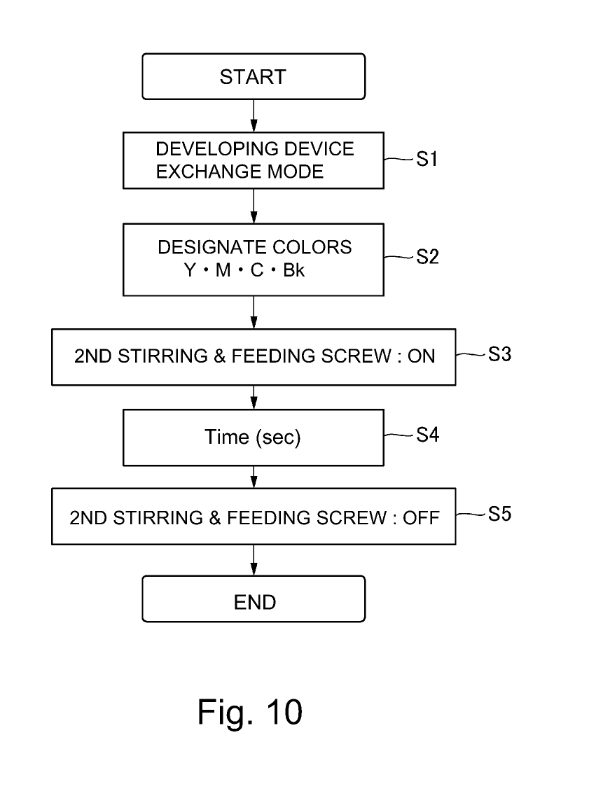

Here, the rotation shaft 46d is rotationally driven by a developing motor 205 (described later with reference to FIG. 7). Further, each of the screw portions is capable of feeding the developer as described above by rotation of the rotation shaft 46d by appropriately setting a tilting direction, an angle and a diameter of the blade. More specifically, as shown in FIG. 4, in the downstream side of the second stirring and feeding screw 46 of the developing device 4 with respect to the developer feeding direction, the discharging opening 47 is provided. Between this discharging opening 47 and the stirring chamber 44 of the developing container 40, as shown in FIGS. 4 to 6, the discharging screw portion 46c is provided. Further, between the main feeding screw portion 46a and the discharging screw portion 46c, the returning screw portion 46b for feeding the developer in the opposite direction to the developer feeding direction of the main feeding screw portion 46a is provided.

In a side downstream of the main feeding screw portion 46a and the returning screw portion 46b with respect to the developer feeding direction, the discharging path 48 for discharging the developer while being continuously connected to a developer feeding path 49 in which the main feeding screw portion 46a is provided is provided. A height level of a bottom 48a of the discharging path 48 is set at a level higher than a height level of a bottom 49a of the feeding path 49. Further, the discharging path 48 is provided with the discharging screw portion 46c for discharging an excessive portion of the developer through the discharging opening 47. The feeding direction of the discharging screw portion 46c is the same as the feeding direction of the main feeding screw portion 46a.

A supplying operation and a collecting operation of the developer in the thus-constituted developing device 4 in this embodiment will be described. As a supply developer, a developer in which the carrier is contained in a certain proportion (about 10% in a weight ratio) is used. This ratio is not limited thereto. The toner in an amount corresponding to an amount of the toner consumed by the image formation is supplied, as the supply developer containing the carrier in the certain proportion is described above, from an upstream side of the second stirring and feeding screw 46 of the developing container 40 with respect to the developer feeding direction by rotation of a supplying screw provided in the developer supplying device 60.

When the supply developer is supplied so as to keep a toner content (concentration) of the developer in the developing container 40 at a constant level, the amount of the developer in the developing container 40 increases with the image formation. The supply developer is consisting of 90% of the toner and 10% of the carrier, and therefore the toner is consumed by the image formation, but the carrier is not consumed and remains in the developing container 40, so that the developer amount increases by repetition of the supply of the developer. In the case where the developer amount increases in such a manner, a part of the developer fed by the main feeding screw portion 46a of the second stirring and feeding screw 46 climbs over the returning screw portion 46b and reaches the discharging path 48. Then, the developer is fed to the discharging opening 47 by the discharging screw portion 46c. The developer fed to the discharging opening 47 is discharged through the discharging opening 47 into a collecting container 61, and is collected and stored in the collecting container 61.

In this way, replacement of the two-component developer is gradually made automatically so as to keep the toner content in the developing container 40 at the constant level while supplying the toner in the amount corresponding to the amount of the consumed toner by the supply developer simultaneously with the discharge of the developer excessive in the supplied carrier.

### [Developer]

Here, the two component developer, which comprises the toner and the carrier, accommodated in the developing container 40 will be further described more specifically.

The toner contains primarily binder resin, and coloring agent. If necessary, particles of coloring resin, inclusive of other additives, and coloring particles having external additive such as fine particles of choroidal silica, are externally added to the toner. The toner is negatively chargeable polyester-based resin and is desired to be not less than 4 μm and not more than 10 μm, preferably not more than 8 μm, in volume-average particle size. The toner in this embodiment has the volume-average particle size of 6 μm and contains a toner component of 8 μm or more in volume-average particle size in an amount of 10% per the entire toner amount and a toner component of 9 μm or more in volume-average particle size in an amount of 3% per the entire toner amount.

As for the material for the carrier, particles of iron, the surface of which has been oxidized or has not been oxidized, nickel, cobalt, manganese, chrome, rare-earth metals, alloys of these metals, and oxide ferrite are preferably usable. The method of producing these magnetic particles is not particularly limited. A weight-average particle size of the carrier may be in the range of 20-60 μm, preferably, 30-50 μm. The carrier may be not less than 10⁷ ohm·cm, preferably, not less than 10⁸ ohm·cm, in resistivity. In this embodiment, the carrier with a resistivity of 10⁸ ohm·cm was used.

Incidentally, the volume-average particle size of the toner used in this embodiment was measured by using the following device and method. As the measuring device, a sheath-flow electric resistance type particle size distribution measuring device (“SD-2000”, manufactured by Sysmex Corp.) was used. The measuring method was as follows. To 100-150 ml of an electrolytic solution which is a 1%-aqueous NaCl solution prepared using reagent-grade sodium chloride, 0.1 ml of a surfactant as a dispersant, preferably, alkylbenzenesulfonic acid salt, was added, and to this mixture, 0.5-50 mg of a measurement sample was added.

Then, the electrolytic solution in which the sample was suspended was dispersed for about 1-3 minutes in an ultrasonic dispersing device. Then, the particle size distribution of the sample, the size of which is in the range of 2-40 μm was measured with the use of the above-mentioned measuring device (“SD-2000”) fitted with a 100 μm aperture, and the volume-average distribution was obtained. Then, a volume-average particle size was obtained from the thus-obtained volume-average distribution.

Further, the resistivity of the carrier used in this embodiment was measured by using a sandwich type cell with a measurement electrode area of 4 cm² and a gap between two electrodes of 0.4 cm². A voltage E (V/cm) was applied between the two electrodes while applying 1 kg of weight (load) to one of the electrodes, to obtain the resistivity of the carrier from the amount of the current which flowed through the circuit.

### [Removing Operation of Developing Device]

An operation when the developing device 4 is removed in this embodiment will be described with reference to FIGS. 7 to 12. FIG. 7 is a schematic view of a control circuit of the image forming apparatus 100 in this embodiment. A controller 200 as a control means of the image forming apparatus 100 in this embodiment includes CPU 201, ROM 202 and RAM 203, and effects image formation by controlling an image forming engine portion 204 including various motors and a power source and the like. The image forming engine portion 204 includes a developing motor 205 as a driving means. The developing motor 205 rotationally drives the first stirring and feeding screw 45, the second stirring and feeding screw 46 and the developing sleeve 42 of the developing device 4. Further, to the controller 200, an operating portion (UI: user interface) 300 as an inputting portion is connected. As a specific example of the operating portion 300, it is possible to cite an operating panel provided on the apparatus main assembly 101, an external input terminal (station) such as a personal computer, and so on.

The CPU 201 causes the RAM 203 to store the number of times of the image formation (e.g., the number of sheets subjected to the image formation, the number or time of rotation of the developing sleeve). Then, when the number of times of the image formation reaches the number of a lifetime counter set in advance for the developing device 4, the CPU 201 causes the operating portion (outputting portion) 300 to display a sign (message) for prompting a user (operator) to perform a developing device exchange operation (providing an instruction to remove the developing device 4). Here, in a state in which the sign is displayed, the image forming apparatus is in a state in which an operation with the image formation is at rest. The operation with the image formation includes, in addition to a normal image forming operation, an interval between an image and a subsequent image during continuous image formation (sheet interval), a pre-rotation operation and a post-rotation operation. The pre-rotation operation is an operation for driving the photosensitive drum and the like for a predetermined time before the image forming operation is started, and the post-rotation operation is an operation for driving the photosensitive drum and the like for a predetermined time after the image forming operation is ended. In either case, the developing device 4 is driven, and in the state in which the sign is displayed, the drive of the developing device 4 is at rest. An example of the operating portion 300 is shown in FIG. 8. At the operating portion 300, as shown in (a) of FIG. 8, a display portion 301 capable of displaying various signs is disposed. An example of the sign for prompting the user (operator) to perform the developing device exchange operation is shown in (b) of FIG. 8. In addition, the display portion 301 displays an error (information about abnormality of the image forming apparatus) when abnormality occurs in the image forming apparatus as shown in (c) of FIG. 8. Incidentally, in the case where such a sign or error is displayed on the external input terminal, the CPU 201 functions as an outputting portion for outputting the sign or the error to the external input terminal.

In this embodiment, as an example, the case where the user exchanges the developing device 4 will be described. As described above, the sign for the developing device exchange is displayed at the display portion 301, and then when the user presses a user mode button 302 ((a) of FIG. 8) of the operating portion 300, a screen shown in (a) of FIG. 9 is displayed at the display portion 301. Then, when the user touches an adjusting mode button 303, at the display portion 301, a screen shown in (b) of FIG. 9 is displayed. Then, when the user touches a developing device exchange mode button 304, at the display portion 301, a screen shown in (c) of FIG. 9 is displayed. Then, the user designate the color (4 species of Y, M, C and Bk in this embodiment, but the color is not restricted thereto), so that the user starts the exchange operation of the designated developing device.

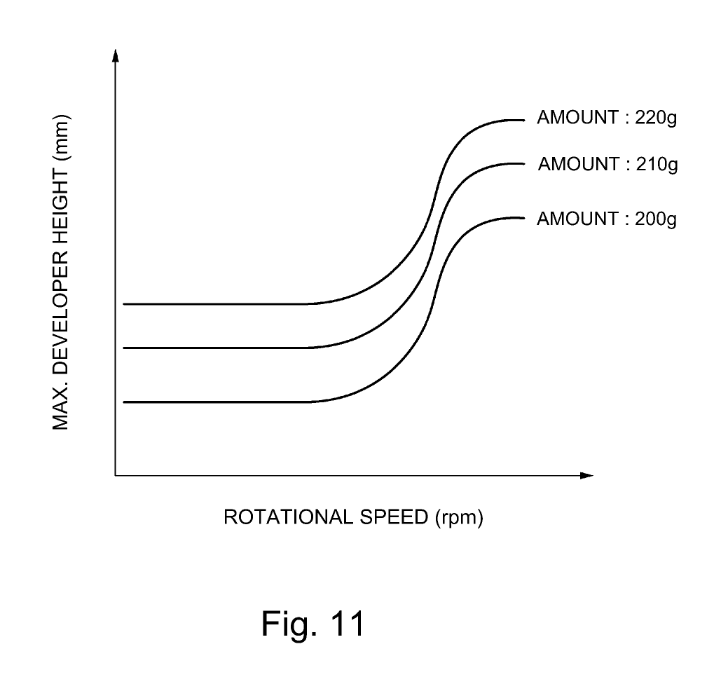

As shown in FIG. 10, when the user touches the developing device exchange mode button 304 on the screen of (b) of FIG. 9, an operation in the developing device exchange mode is started, and the CPU 201 receiving the instruction from the operating portion 300 starts a preparation for sending the instruction to the developing motor 205 (S1). Then, on the screen of (c) of FIG. 9, the user selects the color designated by the operating portion 300, so that the user selects the developing motor for the developing device to be operated (exchanged) (S2). Then, the developing motor 205, of the image forming engine motor, which received the instruction from the CPU 201 and which is used for the developing device of the designated color is driven to start an operation for rotating the second stirring and feeding screw 46 of the associated developing device 4 (S3). Then, a time of the developing motor 205 designated in advance in the ROM 202 is checked. In this embodiment, setting is made so that the second stirring and feeding screw 46 rotates for 10 sec (S4). Then, when the second stirring and feeding screw 46 rotates until the designated time, the developing motor 205 is stopped (S5). When the drive of the developing motor 205 is stopped, the operation in the developing device exchange mode is ended, so that the developing device is removable.

In this way, in this embodiment, in the case where the developing device is removed (demounted) from the apparatus main assembly 101, the second stirring and feeding screw 46 is driven after the drive with the image formation is at rest and before the developing device 4 is removed from the apparatus main assembly 101. That is, the CPU 201 of the controller 200 drives the developing motor 205 when the developing device 4 is removed after the operation with the image formation including the post-rotation operation is stopped and also the drive of the developing device 4 is once stopped. Specifically, in the case where the developing device removing instruction is provided by the operating portion 300, the developing motor 205 of the developing device 4 once stopped is driven. As a result, the second stirring and feeding screw 46 rotates, so that also the discharging screw portion 46c is rotated, and therefore the developer accumulated in the discharging path 48 is discharged into the collecting container 61 through the discharging opening 47.

Here, in this embodiment, a rotational speed of the developing motor 205 for rotating the second stirring and feeding screw 46 was made equal to that during the normal image formation. However, the rotational speed of the developing motor 205 may also be faster or slower than that during the normal image formation. Incidentally, in the case where the rotational speed of the developing motor 205 when the developing device 4 is removed is made faster than that during the image formation, a developer surface height increases in some cases, so that it takes much time to discharge the developer in the discharging path 48 in some cases. On the other hand, in the case where the rotational speed is made slow, a force for raising the developer and thus the developer surface height is stable at a low level, so that the discharge of the developer in the discharging path 48 does not require much time. Accordingly, it is preferable that the driving speed of the second stirring and feeding screw 46 when the developing device 4 is removed is made slower than the driving speed of the second stirring and feeding screw 46 during the image formation. In either case, the driving time of the developing motor 205 se in advance as described above may preferably be set so that the developer in the discharging path 48 is discharged through the discharging opening 47 with reliability in consideration of the rotational speed of the developing motor 205 and so on.

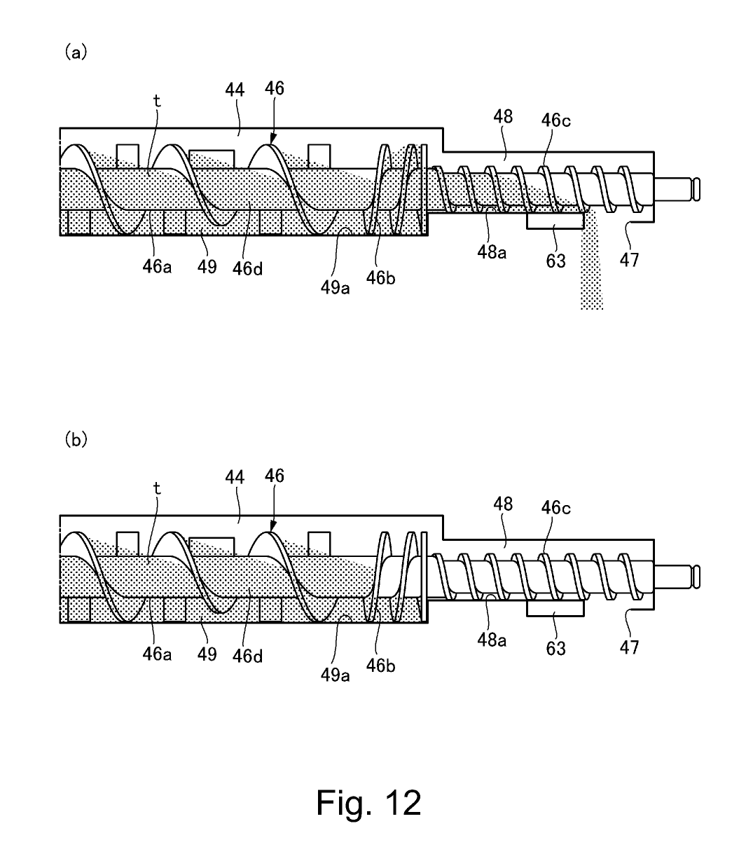

A relationship of the rotational speed of the developing motor 205 and a maximum developer surface height at the returning screw portion 46b was shown in FIG. 11. As shown in the figure, it is understood that the developer surface height decreases with a slower rotational speed to some extent and thus the amount of the developer flowing in the discharging path 48 decreases. That is, when the developer surface height becomes high, also the amount of the developer which climbs over the returning screw portion 46b and which is fed to the discharging path 48 becomes large, so that it takes much time until the fed developer is discharged through the discharging opening 47. Accordingly, it is desirable that the driving speed of the second stirring and feeding screw 46 is calculated and set so that the developer surface height is lower than the height of the returning screw portion 46b.

In the case of this embodiment as described above, by driving the second stirring and feeding screw 46 before the developing device 4 is removed from the apparatus main assembly 101, the developer accumulating in the neighborhood of the discharging opening 47 for permitting the discharge of the developer can be discharged by the discharging screw portion 46c. That is, as shown in (a) of FIG. 12, the second stirring and feeding screw 46 is driven by driving the developing motor 205, the developer t (dotted portion) in the discharging path 48 is fed to the discharging opening 47 by the discharging screw portion 46c. At this time, the developing device 4 is in a state before the developing device 4 is removed from the apparatus main assembly 101, and therefore a shutter 63 for the discharging opening 47 is open, so that the developer t is discharged into the collecting container 61 (FIG. 4) connected to this discharging opening 47. Then, the discharging screw portion 46c is rotated for a predetermined time (10 sec in this embodiment), so that the developer t in the discharging path 48 is discharged as shown in (b) of FIG. 12.

For this reason, according to this embodiment, it is possible to suppress drop of the developer when the developing device 4 is removed from the apparatus main assembly 101. It is possible to suppress the drop of the developer, from the neighborhood of the shutter 63 for the discharging opening 47 into the apparatus main assembly 101 or into a periphery of the apparatus main assembly 101, caused due to, e.g., vibration of the developing device 4 in the removing operation, tilt of the developing device 4 during the removal of the developing device 4, and so on. As a result, the amount of the developer dropping in the neighborhood of the developer discharging opening 47 with execution of the exchange operation of the developing device 4 can be reduced, so that it is possible to prevent contamination with the developer.

Incidentally, in the case of this embodiment, the user operated the operating portion based on the sign for developing device exchange, so that the second stirring and feeding screw 46 was driven for the predetermined time before the removal of the developing device 4. However, when the error of the image forming apparatus 100 is displayed, there is another cause in some cases, but it would be also assumed in some cases that the developer drops into the main assembly due to the vibration or the like of the image forming apparatus during maintenance of the main assembly. For this reason, in such a case, the second stirring and feeding screw 46 of the developing device 4 may also be automatically rotated. That is, the CPU 201 discriminates, as a discriminating means, that there is a need to remove the developing device 4 due to the error. Then, when the CPU 201 discriminates that the removal of the developing device 4 is needed, the developer in the discharging path 48 of the developing device 4 may also be discharged by automatically driving the developing motor 205 as described above. In this way, in the case where the drive of the developing motor 205 is automatically made, the developing motor 205 may also be subsequently driven without stopping the drive with the image formation.

Further, in addition, a hard switch (manually driving means) may also be mounted in the apparatus main assembly 101 so that the second stirring and feeding screw 46 of the developing device 4 is drivable whenever the developing device is replaced (exchanged) during failure in image forming operation. As such a hard switch, such a button that the second stirring and feeding screw 46 is rotated by a pushing-in operation, or a handle or a lever for rotating the second stirring and feeding screw 46 may be used so long as the user manually drives the second stirring and feeding screw 46.

### Second Embodiment

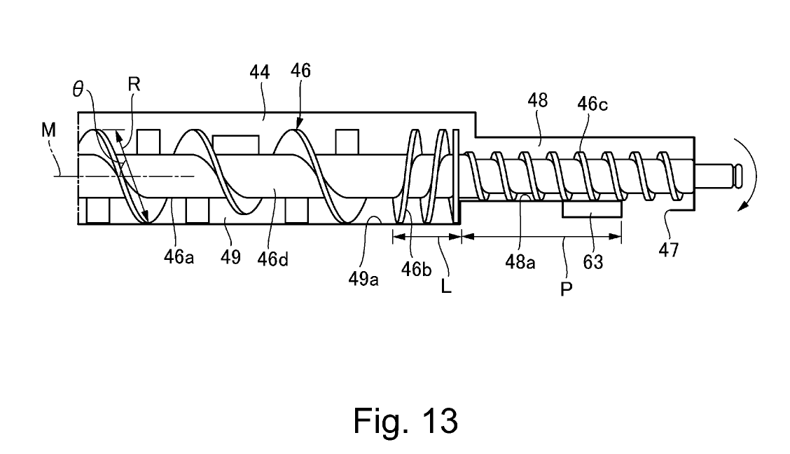

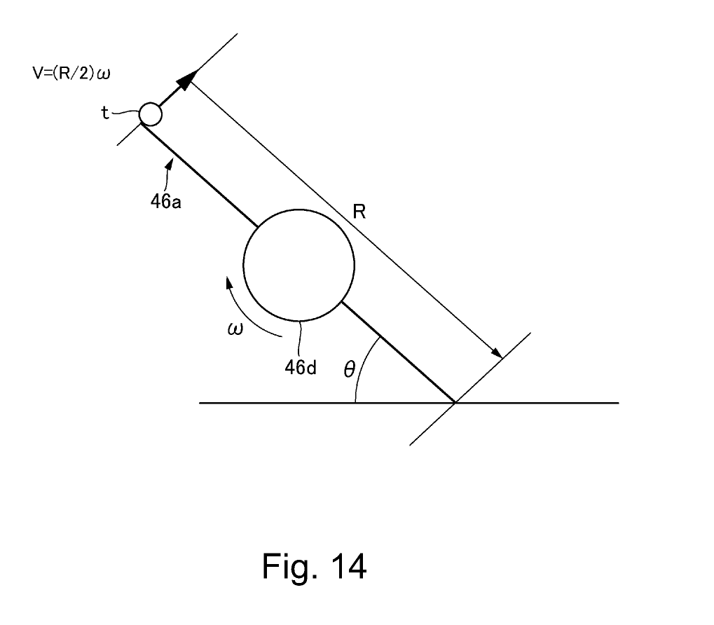

Second Embodiment of the present invention will be described with reference to FIGS. 13 and 14. In the case of the above-described Embodiment 1, during the exchange operation of the developing device 4, the rotating operation of the second stirring and feeding screw 46 was performed for 10 sec. That is, by rotating the second stirring and feeding screw 46 for a long time, the developer in the neighborhood of the discharging opening 47 was discharged with reliability. However, the user feels stress with a longer time in the exchange operation of the developing device 4. Therefore, in this embodiment, depending on a shape of respective portions of the developing device 4, an optimum rotation time of the second stirring and feeding screw 46 during the exchange operation was calculated, so that the exchange operation of the developing device 4 was capable of being performed in a short time to the possible extent. Other constitutions and functions are similar to those in First Embodiment, and therefore constituent elements identical to those in First Embodiment are represented by the same reference numerals or symbols and in the following, a portion different from First Embodiment will be principally described while omitting or simplifying detailed illustration and description.

In FIG. 13, parameters of the stirring chamber 44 and the second stirring and feeding screw 46 of the developing device 4 in this embodiment are shown by symbols or marks. First, the predetermined time for which the second stirring and feeding screw 46 is rotated is T, an angular speed of the discharging screw portion 46c (same as the angular speed of the developing motor 205) is c, and the number of winding of the blade of the discharging screw portion 46c from the returning screw portion 46b to the discharging opening 47 is P. That is, the number of winding of the blade of the discharging screw portion 46c between an end of the returning screw portion 46b in the discharging screw portion 46c side and an end of the discharging opening 47 in the discharging screw portion 4c side is P. In this case, when the predetermined time T is set to satisfy:

T≧(2π/ω)×P (1),

the developer in the discharging path 48 is discharged through the discharging opening 47.

Next, a distance (screw diameter) between a point on a circumference of the blade of the main screw feeding portion 46a and another point, on the circumference, remotest from the point is R. Further, an angle connecting these points with respect to a rotational axis M of the second stirring and feeding screw 46 is θ. Further, a length of the returning screw portion 46b with respect to the developer feeding direction is L, ad gravitational acceleration is g. In this case, the angular speed ω may preferably be set to satisfy:

L≧(R×ω)²×sin θ×cos θ/2/g (2).

This will be described with reference to FIG. 14.

FIG. 14 simply shows the case where the developer t flies (scatters) from the top (point) of the blade of the main feeding screw portion 46a by rotation of the main feeding screw portion 46a. As shown in FIG. 14, the developer t is flown from the main feeding screw portion 46a at a speed V. At this time, in the case where a flying time of the developer t is τ, when the time τ is set to satisfy:

L≧V×cos θ×τ (3),

it can be assumed that the developer t flown from the main feeding screw portion 46a drops into the returning screw portion 46b and does not reach the discharging screw portion 46c. Incidentally, the speed V can be represented by: V=(R/2) ω, and therefore the formula (3) is changed to the following formula (4):

L≧(R/2)ω×sin θ×τ (4).

On the other hand, when a parabolic motion is assumed defining a time, from the fly of the developer t to return of the developer t to a height position (y direction position) which is the same in height as the point where the developer t is flown, as the above-described τ, y is represented by the following formula (5):

y=V×cos θ×τ−(g/2)τ² (5).

Here, the time of y=0 is an elapsed time of the time τ, and the speed V can be represented by V=(R/2)ω, and therefore the formula (5) is changed to the following formula:

0=(R/2)ω×cos θ×τ−(g/2)τ²,

and therefore the time T is represented by the following formula (6):

τ=(ω×R/g)×cos θ (6).

When this formula (6) is substituted in the formula (4), the above-described formula (2) can be obtained. Accordingly, the angular speed ω satisfying the formula (2) is a maximum speed at which the developer t flown from the main feeding screw portion 46a does not reach the discharging screw portion 46c.

From the above, the angular speed ω of the discharging screw portion 46c is set to satisfy the formula (2) and the thus-set as is substituted in the formula (1), whereby the predetermined time in which the developer in the discharging path can be discharged in the shortest time in the constitution can be obtained. That is, by satisfying the formulas (1) and (2), the driving time of the developing motor 205 during the exchange operation of the developing device 4 can be set at a shorter time (the shortest time or the like). Incidentally, in addition, it is desirable that many parameters such as the developer amount and a developer deterioration state are incorporated, but it is confirmed that an effect is achieved by the above-described conversion formulas in many cases.

Here, as an example of the second stirring and feeding screw 46, the lowest rotation speed and the shortest rotation time by a screw shape having the following numerical values are determined.

L=5 mm,P=4 mm,R=16 mm,θ=45°

When the above parameters are substituted in the above-described formula (2), the following relationships are obtained.

5 mm≧(16 mm×ω)²×√2/8/(9.8×10³ mm/sec)ω≦32.9[rad/sec]≈(nearly equal to) 314 [rpm].

T≧0.76 [sec].

This is an example of the screw shape, but the screw shape is not restricted to the above screw shape when the above relationships are satisfied.

In the case of this embodiment, by determining the optimum rotation time of the discharging screw portion 46c, the stress is not applied to the user during the maintenance, exchange and the like of the developing device 4, and in addition, it becomes possible to prevent the contamination with the developer in the neighborhood of the developer discharging opening 47.

Incidentally, in the above-described Embodiments, the case where the developer portion 47 is directed downward with respect to the direction of gravity was described. However, the present invention is also applicable to, e.g., another constitution in which the portion 47 opens to another direction such as the horizontal direction.

### OTHER EMBODIMENTS

In the above-described Embodiments, in the case where the developing device is removed, description was made in such a manner that the driving time for which the second stirring and feeding screw is driven is the certain value, but the present invention is not limited thereto. For example, in the case where the amount of the developer in the developing container (discharging portion) is small immediately before the removal of the developing device, the driving time can be shortened. Therefore, the developer amount in the discharging portion is estimated from a ratio of the printed image or the toner consumption amount (toner supply amount) immediately before the removal of the developing device, and then the driving time of the second stirring and feeding screw may also be changed. That is, in the case where the image ratio is small, discrimination that the amount of the developer in the discharging portion is small is made, and then the driving time of the second stirring and feeding screw may also be set at a small value.

Further, in the above-described Embodiments, the developer accumulating in the neighborhood of the discharging opening was described, but the present invention is applicable to also the supply opening provided in the developing device. That is, when the developing device is taken out, a feeding member provided in the neighborhood of the supply opening is driven. As a result, the developer accumulating in the neighborhood of the supply opening can be fed into the developing container, and it is possible to suppress drop of the developer through the supply opening when the developing device is removed from the apparatus main assembly.

According to the present invention, by driving the feeding member in the case where the instruction to remove the developing device from the apparatus main assembly is provided or in the like case, the developer accumulating in the neighborhood of the discharging opening for permitting the discharge of the developer can be discharged by the discharging feeding portion. For this reason, it is possible to suppress the drop of the developer when the developing device is removed from the apparatus main assembly.

While the invention has been described with reference to the structures disclosed herein, it is not confined to the details set forth and this application is intended to cover such modifications or changes as may come within the purpose of the improvements or the scope of the following claims.

This application claims the benefit of Japanese Patent Applications Nos. 2014-137416 filed on Jul. 3, 2014 and 2014-137417 filed on Jul. 3, 2014, which are hereby incorporated by reference herein in their entirety.

What is claimed is:

1. An image forming apparatus comprising:
a main assembly;
a developing device removable from said main assembly and including a developing container provided with a discharge opening for permitting discharge of a developer and a feeding member for feeding the developer in the developing container;
a driving device for driving the feeding member;
a controller for controlling said driving device; and
an outputting portion for outputting information providing an instruction to remove said developing device or information about abnormally of said image forming apparatus,
wherein the developing container includes an accommodating portion for accommodating the developer and a discharging portion for feeding the developer to the discharge opening by being connected to the accommodating portion,
wherein the feeding member is constituted by integrally connecting a main feeding portion, provided in the accommodating portion, for feeding the developer in the accommodating portion toward the discharging portion, a sub-feeding portion for feeding the developer in an opposite direction to a developer feeding direction of the main feeding portion in front of the discharging portion in the accommodating portion, and a discharging feeding portion, provided in the discharging portion, for feeding toward the discharging opening the developer fed from the accommodating portion to the discharging portion over the sub-feeding portion, and
wherein said controller drives said driving device for a predetermined time when the information is outputted from said outputting portion.

2. An image forming apparatus comprising:
a main assembly;
a developing device removable from said main assembly and including a developing container provided with a discharge opening for permitting discharge of a developer and a feeding member for feeding the developer in the developing container;
a driving device for driving the feeding member;
a controller for controlling said driving device; and
an inputting portion for inputting information for providing an instruction to remove said developing device,
wherein the developing container includes an accommodating portion for accommodating the developer and a discharging portion for feeding the developer to the discharge opening by being connected to the accommodating portion,
wherein the feeding member is constituted by integrally connecting a main feeding portion, provided in the accommodating portion, for feeding the developer in the accommodating portion toward the discharging portion, a sub-feeding portion for feeding the developer in an opposite direction to a developer feeding direction of the main feeding portion in front of the discharging portion in the accommodating portion, and a discharging feeding portion, provided in the discharging portion, for feeding toward the discharging opening the developer fed from the accommodating portion to the discharging portion over the sub-feeding portion, and
wherein said controller drives said driving device for a predetermined time when the information is inputted from said inputting portion.

3. An image forming apparatus according to claim 1, wherein said controller makes a driving speed of the feeding member when said developing device is removed slower than a driving speed of the feeding member during image formation.

4. An image forming apparatus according to claim 1, wherein the discharging feeding portion is a screw having a helical blade on a rotation shaft, and
wherein when the predetermined time is T, an angular speed of the discharging feeding portion is ω, and the number of winding of the blade from the sub-feeding portion to the discharging opening at the discharging feeding portion is P, the predetermined time T is set to satisfy the following relationship:
T≧(2π/ω)×P.

5. An image forming apparatus according to claim 1, wherein the main feeding portion is a screw having a helical blade on a rotation shaft, and
wherein when a distance between a point on a circumference of the blade of the main feeding portion and another point, on the circumference, remotest from the point is R, an angle connecting these points with respect to the rotation shaft is θ, a length of the sub-feeding portion with respect to the developer feeding direction is L, ad gravitational acceleration is g, the angular speed ω is set to satisfy the following relationship:
L≧(R×ω))²×sin θ×cos θ/2/g.
